(19) United States
(12) Patent Application Publication
(10) Pub. No.: US 2020/0030787 A1
(43) Pub. Date: Jan. 30, 2020

(54) Ion-Conducting Membranes

(71) Applicant: Dioxide Materials, Inc., Boca Raton, FL (US)

(72) Inventors: Richard I. Masel, Boca Raton, FL (US); Syed Dawar Sajjad, Boca Raton, FL (US); Qingmei Chen, Savoy, IL (US); Zengcai Liu, Boca Raton, FL (US)

(21) Appl. No.: 16/552,952

(22) Filed: Aug. 27, 2019

Related U.S. Application Data
(63) Continuation-in-part of application No. 15/810,106, filed on Nov. 12, 2017.
Application No. 15/810,106 is a continuation-in-part of application No. 15/400,775, filed on Jan. 6, 2017, now Pat. No. 9,849,450.
Application No. 15/400,775 is a continuation-in-part of application No. 15/090,477, filed on Apr. 4, 2016, now Pat. No. 9,580,824.
Application No. 15/090,477 is a continuation-in-part of application No. 14/704,935, filed on May 5, 2015, now Pat. No. 9,370,773.
Application No. 14/704,935 is a continuation-in-part of application No. PCT/US2015/014328, filed on Feb. 3, 2015.
Application No. 14/704,935 is a continuation-in-part of application No. PCT/US2015/026507, filed on Apr. 17, 2015.
(60) Provisional application No. 62/066,823, filed on Oct. 21, 2014.
(60) Provisional application No. 62/066,823, filed on Oct. 21, 2014.

(51) Int. Cl. B01J 41/14; B01D 71/28; C25B 13/08; H01M 8/1023; H01M 8/1039; H01M 8/1067; C02F 1/44; C08J 5/22

(52) U.S. Cl. CPC B01J 41/14; B01D 71/28; C25B 13/08; H01M 8/1023; H01M 2008/1095; H01M 8/1067; C02F 1/44; C08J 5/2243; H01M 8/1039

(57) ABSTRACT

An anion-conducting polymeric membrane comprises vinylbenzyl-Rₛ vinylbenzyl-Rₓ and styrene-Rₜ. Rₛ is a positively charged amine or phosphine group. The total weight of the vinylbenzyl-Rₛ groups is greater than 15% of the total weight of the membrane.

### CROSS-REFERENCE TO RELATED APPLICATIONS

The present application is a continuation in part of U.S. patent application Ser. No. 15/810,106 filed on Nov. 12, 2017, entitled “Ion-Conducting Membranes”. The '106 patent is, in turn, a continuation-in-part of U.S. patent application Ser. No. 15/400,775 filed on Jan. 6, 2017 (now U.S. Pat. No. 9,849,450 issued on Dec. 26, 2017), also entitled “Ion-Conducting Membranes”. The '775 application is, in turn, a continuation in part of U.S. patent application Ser. No. 15/090,477 filed on Apr. 4, 2016 (now U.S. Pat. No. 9,580,824 issued on Feb. 28, 2017), also entitled “Ion-Conducting Membranes”. The '477 application is, in turn, a continuation-in-part of U.S. patent application Ser. No. 14/704,935 filed on May 5, 2015, also entitled “Ion-Conducting Membranes” (now U.S. Pat. No. 9,370,773 issued on Jun. 21, 2016). The '935 application was, in turn, a continuation-in-part of International Application No. PCT/US2015/14328, filed on Feb. 3, 2015, entitled “Electrolyzer and Membranes”. The '328 international application claimed priority benefits, in turn, from U.S. provisional patent application Ser. No. 62/066,823, filed on Oct. 21, 2014.

The '935 application was also a continuation-in-part of International Application No. PCT/US2015/26507 filed on Apr. 17, 2015, entitled “Electrolyzer and Membranes”. The '507 international application also claimed priority benefits, in turn, from U.S. provisional patent application Ser. No. 62/066,823 filed on Oct. 21, 2014.

The '106 parent application, the '775 application, the '477 application, the '935 application, the '823 provisional application, and the '328 and '507 international applications are each hereby incorporated by reference herein in their entirety.

This application is also related to U.S. patent application Ser. No. 14/035,935 filed on Sep. 24, 2013, entitled “Devices and Processes for Carbon Dioxide Conversion into Useful Fuels and Chemicals” (now U.S. Pat. No. 9,370,733; U.S. patent application Ser. No. 12/830,338 filed on Jul. 4, 2010, entitled “Novel Catalyst Mixtures”; International application No. PCT/2011/030098 filed Mar. 25, 2011, entitled “Novel Catalyst Mixtures”; U.S. patent application Ser. No. 13/174,365 filed on Jun. 30, 2011, entitled “Novel Catalyst Mixtures”; International application No. PCT/US2011/042809 filed Jul. 1, 2011, entitled “Novel Catalyst Mixtures”; U.S. patent application Ser. No. 13/530,058 filed on Jun. 21, 2012, entitled “Sensors for Carbon Dioxide and Other End Uses”; International application No. PCT/US2012/043651 filed on Jun. 22, 2012, entitled “Low Cost Carbon Dioxide Sensors”; and U.S. patent application Ser. No. 13/445,887 filed on Apr. 12, 2012, entitled “Electrocatalysts for Carbon Dioxide Conversion”.

### FIELD OF THE INVENTION

The field of the invention is electrochemistry. The compositions and membranes are useful for the electrolysis of water and carbon dioxide, batteries, electric power generation using fuel cells, water purification and carbon dioxide capture systems.

### BACKGROUND OF THE INVENTION

U.S. Pat. Nos. 9,370,773, 9,481,939, 9,580,824, 9,815,021, 9,849,450, 9,943,841, 9,945,040, 9,957,624, 9,982,353, 10,047,446, 10,147,974, 10,173,169, and U.S. patent application Ser. Nos. 15/810,106, 15/908,325, 15/922,883, 15/967,293, 16/024,827, 16/164,289, 16/238,425, and 16/429,868 (Masel et al.) disclose a number of ion conducting membranes. These membranes were optimized for carbon dioxide electrolysis.

Disclosed herein are membranes that are useful, if not superior, for the electrolysis of water, batteries, electric power generation using fuel cells, and water purification and carbon dioxide capture systems.

### SUMMARY OF THE INVENTION

An anion-conducting membrane comprising a polymer comprising the reaction products of vinylbenzyl-Rₛ, vinylbenzyl-Rₓ and styrene-Rₜ wherein
(a) Rₛ is a positively charged amine group or phosphene
(b) Rₓ is independently selected from OH—, halogens, linear alkyls, branched alkyls, cyclic alkyls, heteroalkyls, aryls, heteroaryls, alkylaryls, heteroalkylaryls or polymers thereof.
(c) Rₜ is independently selected from hydrogen, OH—, halogens, linear alkyls, branched alkyls, cyclic alkyls, heteroalkyls, aryls, heteroaryls, alkylaryls, and heteroalkylaryls.
(d) Rₓ is a different chemical species than Rₛ
(e) styrene-Rₜ is a different chemical species than vinylbenzyl-Rₛ and vinylbenzyl-Rₓ
(f) the total weight of the vinylbenzyl-Rₛ is at least 10% of the weight of the polymer
(g) the total weight of the vinylbenzyl-Rₓ is at least 1% of the weight of the polymer
(h) the total weight of the styrene-Rₜ is at least 1% of the weight of the polymer.

In a preferred embodiment the total weight of the styrene-Rₜ is at least 10% of the weight of the polymer.

In a preferred embodiment, vinylbenzyl-Rₛ comprises the reaction product of a benzyl-X, wherein X is a halogen, with at least one of: 1,2,2,6,6-pentamethylpiperidine, 1,2,2,5,5-pentamethylpyrrolidine, tetramethylimidazole, triethylamine, tripropylamine, trimethylamine, N-methylpiperdine, 1-ethylpiperidine, piperidine, 1,4′-bipiperidine, 1-methylpyrrolidine, 2,2,6,6-tetramethylpiperidine, pyrrolidine, 1-pyrrolidine ethanamine, 2,3,5-trimethylpyridine, 2,4,6-trimethylpyridine, 2,6-dimethylpyridine, 2,4-dimethylpyridine, 2,3,5-trimethylpyridine, 4-methyl-2-(1-pyrrolyl)pyridine, 2-methylpyridine, 3-methylpyridine, 4-methylpyridine, pyridine, 4,4′-dipyridyl, 2,2′-bipyridyl, tributylamine, N,N-diisopropylethylamine, triphenylamine, N,N-dimethylcyclohexylamine, N,N-dicyclohexylmethylamine, triphenylphosphine, 1,2-dimethylindole, indole, 1-methylindole, hexamethylenetetramine, 2,3,5,6-tetramethylpyrazine, 2,3,5-trimethylpyrazine, 2,3-dimethylpyrazine, 3-methylpyridazine, 2-methylpyrazine, 2,3-diethylpyrazine, ethylpyrazine, pyrazine, 1-methylimidazole, pyrimidine, 4-methylpyrimidine, pyridazine, triazole, 3,5-dimethyl-1,2,4-triazole, 1,2-dimethylimidazole, 2,4,5-triphenylimidazole, 1-decyl-2-methylimidazole, 1-(2-hydroxyethyl)imidazole, guanidine, tetramethyl guanidine, dipiperidine, dipyridine, ethylenediamine, propylenediamine, N,N,N′-trimethylethylenediamine, ethylenediaminetetraacetic acid, alkyldiamines, other diamines, ethanolamine, triethanolamine, methylethanolamine, dimethylethanolamine, propanolamine, 3-butenylmagnesium, isobutylmagnesium bromide, cyclohexylmagnesium chloride, and amino acid.

In a preferred embodiment, vinylbenzyl-Rₓ comprises at least one of: (i) benzyl-OH, (ii) benzyl-X, wherein X is a halide, (iii) a benzyl crosslinked to vinylbenzyl-Rₛ, styrene-Rₜ or a different vinylbenzyl-Rₓ, and (iv) the reaction product of a benzyl-X with at least one of: 1,2,2,6,6-pentamethylpiperidine, 1,2,2,5,5-pentamethylpyrrolidine, tetramethylimidazole, triethylamine, tripropylamine, trimethylamine, N-methylpiperdine, 1-ethylpiperidine, piperidine, 1,4′-bipiperidine, 1-methylpyrrolidine, 2,2,6,6-tetramethylpiperidine, pyrrolidine, 1-pyrrolidine ethanamine, 2,3,5-trimethylpyridine, 2,4,6-trimethylpyridine, 2,6-dimethylpyridine, 2,4-dimethylpyridine, 2,3,5-trimethylpyridine, 4-methyl-2-(1-pyrrolyl)pyridine, 2-methylpyridine, 3-methylpyridine, 4-methylpyridine, pyridine, 4,4′-dipyridyl, 2,2′-bipyridyl, tributylamine, N,N-diisopropylethylamine, triphenylamine, N,N-dimethylcyclohexylamine, N,N-dicyclohexylmethylamine, triphenylphosphine, 1,2-dimethylindole, indole, 1-methylindole, hexamethylenetetramine, 2,3,5,6-tetramethylpyrazine, 2,3,5-trimethylpyrazine, 2,3-dimethylpyrazine, 3-methylpyridazine, 2-methylpyrazine, 2,3-diethylpyrazine, ethylpyrazine, pyrazine, 1-methylimidazole, pyrimidine, 4-methylpyrimidine, pyridazine, triazole, 3,5-dimethyl-1,2,4-triazole, 1,2-dimethylimidazole, 2,4,5-triphenylimidazole, 1-decyl-2-methylimidazole, 1-(2-hydroxyethyl)imidazole, guanidine, tetramethyl guanidine, dipiperidine, dipyridine, ethylenediamine, propylenediamine, N,N,N′-trimethylethylenediamine, ethylenediaminetetraacetic acid, alkyldiamines, other diamines, ethanolamine, triethanolamine, methylethanolamine, dimethylethanolamine, propanolamine, 3-butenylmagnesium, isobutylmagnesium bromide, cyclohexylmagnesium chloride, and amino acid.

In an alternate embodiment at least one of Rₛ, and Rₓ are not positively charged cyclic amines, Cl or OH.

In an alternate embodiment both Rₛ, and Rₓ are not positively charged cyclic amines, Cl or OH.

In an alternate embodiment Rₛ, Rₜ and Rₓ are each not positively charged cyclic amines, Cl or OH.

In a preferred embodiment Vinylbenzyl-Rₓ and Styrene-Rₜ are not divinylbenzene.

In a preferred embodiment Rₜ is a hydrogen or a linear alkyl.

In a preferred embodiment, the polymer will have a molecular weight between 1000 and 10,000,000 atomic units (A.U.) preferably between 10,000 and 1,000,000 A.U., most preferably between 25,000 and 250,000 A.U.

In a preferred embodiment, the polymeric composition is in the form of a membrane. The membrane has a preferred thickness of 10-300 micrometers.

In a preferred embodiment the membrane has an area specific resistance of 0.1 ohm-cm² or less.

### DETAILED DESCRIPTION OF ILLUSTRATIVE EMBODIMENT(S)

It is understood that the process is not limited to the particular methodology, protocols and reagents described herein, as these can vary as persons familiar with the technology involved here will recognize. It is also to be understood that the terminology used herein is used for the purpose of describing particular embodiments only, and is not intended to limit the scope of the process. It also is to be noted that as used herein and in the appended claims, the singular forms “a,” “an,” and “the” include the plural reference unless the context clearly dictates otherwise. Thus, for example, a reference to “a linker” is a reference to one or more linkers and equivalents thereof known to those skilled in the art. Similarly, the phrase “and/or” is used to indicate one or both stated cases can occur, for example, A and/or B includes (A and B) and (A or B).

Unless defined otherwise, technical and scientific terms used herein have the same meanings as commonly understood by one of ordinary skill in the art to which the process pertains. The embodiments of the process and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment can be employed with other embodiments as the skilled artisan would recognize, even if not explicitly stated herein.

Any numerical value ranges recited herein include all values from the lower value to the upper value in increments of one unit, provided that there is a separation of at least two units between any lower value and any higher value. As an example, if it is stated that the concentration of a component or value of a process variable such as, for example, size, angle size, pressure, time and the like, is, for example, from 1 to 98, specifically from 20 to 80, more specifically from 30 to 70, it is intended that values such as 15 to 85, 22 to 68, 43 to 51, 30 to 32, and the like, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

Moreover, provided immediately below is a “Definitions” section, where certain terms related to the process are defined specifically. Particular methods, devices, and materials are described, although any methods and materials similar or equivalent to those described herein can be used in the practice or testing of the process.

### Definitions

The term “polymer electrolyte membrane” as used here refers to both cation exchange membranes, which generally comprise polymers having multiple covalently attached negatively charged groups, and anion exchange membranes, which generally comprise polymers having multiple covalently attached positively charged groups. Typical cation exchange membranes include proton conducting membranes, such as the perfluorosulfonic acid polymer available under the trade designation NAFION from E. I. du Pont de Nemours and Company (DuPont) of Wilmington, Del.

The term “anion exchange membrane electrolyzer” as used here refers to an electrolyzer with an anion-conducting polymer electrolyte membrane separating the anode from the cathode.

The term “EMIM” as used here refers to 1-ethyl-3-methylimidazolium cations.

The Term “CV” refers to cyclic voltammetry.

The term “Millipore water” is water that is produced by a Millipore filtration system with a resistivity of at least 18.2 megaohm-cm.

The term “imidazolium” as used here refers to a positively charged ligand containing an imidazole group. This includes a bare imidazole or a substituted imidazole. Ligands of the form:

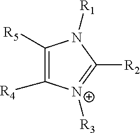

where R₁-R₅ are each independently selected from hydrogen, halides linear alkyls, branched alkyls, cyclic alkyls, heteroalkyls, aryls, heteroaryls, alkylaryls, heteroalkylaryls, and polymers thereof, such as the vinyl benzyl copolymers described herein, are specifically included.

The term “pyridinium” as used here refers to a positively charged ligand containing a pyridine group. This includes a bare pyridine or a substituted pyridine. Ligands of the form:

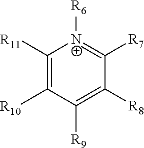

where R₆-R₁₁ are each independently selected from hydrogen, halides, linear alkyls, branched alkyls, cyclic alkyls, heteroalkyls, aryls, heteroaryls, alkylaryls, heteroalkylaryls, and polymers thereof, such as the vinyl benzyl copolymers described herein, are specifically included.

The term “phosphonium” as used here refers to a positively charged ligand containing phosphorous. This includes substituted phosphorous. Ligands of the form:

P⁺(R₁₂R₁₃R₁₄R₁₅)

where R₁₂-R₁₅ are each independently selected from hydrogen, halides, linear alkyls, branched alkyls, cyclic alkyls, heteroalkyls, aryls, heteroaryls, alkylaryls, heteroalkylaryls, and polymers thereof, such as the vinyl benzyl copolymers described herein, are specifically included.

The term “positively charged cyclic amine” as used here refers to a positively charged ligand containing a cyclic amine. This specifically includes imidazoliums, pyridiniums, pyrazoliums, pyrrolidiniums, pyrroliums, pyrimidiums, piperidiniums, indoliums, triaziniums, and polymers thereof, such as the vinyl benzyl copolymers described herein, are specifically included.

The term “simple amine” as used here refers to a species of the form

N(R₁₆R₁₇R₁₈),

wherein R₁₆, R₁₇ and R₁₈ are each independently selected from hydrogen, linear alkyls, branched alkyls, cyclic alkyls, heteroalkyls, aryls, heteroaryls, alkylaryls, heteroalkylaryls, but not polymers.

The term “substituted ethene” as used here refers to a monomer of the form:

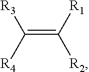

wherein R₁-R₄ are each independently selected from hydrogen, halides, linear alkyls, branched alkyls, cyclic alkyls, heteroalkyls, aryls, heteroaryls, alkylaryls, heteroalkylaryls, including polymers.

The term “water purification system” as used here refers to a device that removes unwanted constituents from water and, in the case of a membrane-based device, one that employs a membrane as a barrier that allows certain substances to pass through while blocking others.

The term “battery” as used here refers to a device that generates electricity via an electrochemical reaction between substances stored internally within the battery.

The term “fuel cell” as used here refers to a device that generates electricity via an electrochemical reaction between substances that are supplied to the fuel cell from an external source.

The term “electrolyzer” as used here refers to an electrochemical device that uses electrical energy to convert a substance into constituent substances. In the case of a water electrolyzer, the device uses electricity to convert water into hydrogen and oxygen.

The term “CO₂ capture system” as used here refers to a device that is able to separate CO₂ from a gas or liquid stream.

### Specific Description

The examples provided here are merely illustrative and are not meant to be an exhaustive list of all possible embodiments, applications or modifications of the present electrochemical device. Thus, various modifications and variations of the described methods and systems of the invention will be apparent to those skilled in the art without departing from the scope of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

### Specific Example 1: Production of Alternative Membranes

The objective of this example is to provide a number of alternate membranes that are useful for the electrolysis of water and carbon dioxide, batteries, electric power generation using fuel cells and water purification.

Generally, the synthesis procedure follows that in U.S. Pat. No. 9,370,773.

Step 1: Inhibitor free styrene was prepared by washing styrene (Sigma Aldrich, Saint Louis, Mo.) with two equal volumes of 7.5% aqueous sodium hydroxide. The inhibitor free styrene was then washed with four equal volumes of water to make sure it was neutralized, and was then dried over anhydrous magnesium sulfate. The tert-butylcatechol (TBC) inhibitor in the vinylbenzyl chloride (VBC) was removed by extraction with 0.5% potassium hydroxide solution until a colorless extract was obtained. This extract was washed with water until neutral and then was dried over anhydrous magnesium sulfate.

Step 2: Poly(vinylbenzyl chloride-co-styrene) was then synthesized by heating a solution of inhibitor free styrene (Sigma-Aldrich) (10.0581 g, 96.57 mmol) and vinylbenzyl chloride (Sigma-Aldrich) (6.2323 g, 40.84 mmol) in chlorobenzene (Sigma-Aldrich) (15 ml) at 60-65° C. in an oil bath for 12-18 hours under argon gas with AIBN (α,α′-Azoisobutyronitrile, Sigma-Aldrich) (0.1613 g, 0.99 wt % based on the total monomers weight) as initiator. The copolymer was precipitated in ethanol and dried under vacuum.

Step 3: The resultant copolymer was dissolved in 1-Methoxy-2-propanol (Sigma Aldrich) to form a solution that was about 30% by weight of polymer.

Step 4: The solution from step 3 was heated to 60° C., and 1-Decyl-2-methylimidazole was added and the solution was continuously stirred for 48 hours.

Additional polymer solutions were prepared by replacing the 1-Decyl-2-methylimidazole with each of the following compounds: 1,1,3,3-Tetramethylguanidine, 1-Ethylpiperidine, 1-methylpyrrolidine, 2,2′-Bipyridyl, 2,3,5-Trimethylpyridine, 2-Methylpyridine, Pyridine, 3-Methylpyridine, 4,4′-dipyridyl, 4-Methylpyridine, N,N,N′,N′-Tetramethyl-1,6-hexanediamine, N,N-Dicyclohexylmethylamine, 1-(2-hydroxyethyl)imidazole, N,N-Dimethylcyclohexylamine, N-methyl Piperdine, Tetramethyl Imidazole, 1-methylimidazole, 1,2-dimethyl imidazole, Tributyl amine, triethyl amine, Trimethyl amine, Triphenyl phosphine, Tripropyl amine, 1,3-diaminopropane, Ethylenediamine, (Methylamino)ethanol, Triethanolamine, Ethanolamine, Ethylenediaminetetraacetic acid, Trimethylethylenediamine, 3-amino-1-propanol, Piperidine, 1,4′-Bipiperidine, 2,2,6,6-Tetramethylpiperidine, Pyrrolidine, 4,4′-dipyridyl, Triphenyl amine, 1,2-Dimethylindole, 1-Methylindole, Hexamethylenetetramine.

Step 5: Next, an attempt was made to manufacture membranes from each of the solutions prepared in step 4 by casting them directly onto a polyethylene terephthalate (PET) liner. The thickness of the solution on the PET was controlled by a film applicator (MTI Corporation, Richmond, Calif.) with an adjustable doctor blade. The membranes were then dried in a vacuum oven at 80° C. for 300 minutes, and then 120° C. for 200 minutes.

Membranes were successfully prepared from the following amines: 1,1,3,3-Tetramethylguanidine, 1-Decyl-2-methylimidazole, 1-Ethylpiperidine, 1-methylpyrrolidine, 2,2′-Bipyridyl, 2,3,5-Trimethylpyridine, 2-Methylpyridine, Pyridine, 3-Methylpyridine, 4,4′-dipyridyl, 4-Methylpyridine, N,N,N′,N′-Tetramethyl-1,6-hexanediamine, N,N-Dicyclohexylmethylamine, 1-(2-hydroxyethyl)imidazole, N,N-Dimethylcyclohexylamine, N-methyl Piperdine, Tetramethyl Imidazole, 1-methylimidazole, 1,2-dimethyl imidazole, Tributyl amine, triethyl amine, Trimethyl amine, Triphenyl phosphine, Tripropyl amine.

The solutions made using 1,3-diaminopropane, Ethylenediamine, (Methylamino)ethanol, Triethanolamine, Ethanolamine, Ethylenediaminetetraacetic acid, Trimethylethylenediamine, 3-amino-1-propanol, Piperidine, 1,4′-Bipiperidine, 2,2,6,6-Tetramethylpiperidine, Pyrrolidine, 4,4′-dipyridyl, Triphenyl amine, 1,2-Dimethylindole, 1-Methylindole, Hexamethylenetetramine had too high of a viscosity to be cast with the MTI casting machine, but it is believed that they could have been cast using different equipment.

Nuclear Magnetic Resonance (NMR) indicated that in each case between 20 and 40% of the vinylbenzyl chloride (VBC) was unreacted, so that the unreacted VBC represented between 5 and 30% of the total weight of the membrane.

Measurements were performed where N,N-Dimethylformamide (DMF) was substituted for the Dowanol in Step 4. In those cases, the unreacted VBC was only about 1-3% of the weight of the polymer.

The specific area resistance of the each of the membranes produced in Specific Example 1 was also measured. In all cases the resultant membranes had an area specific resistance below 0.1 ohm-cm² in 1 M KOH so that they are useful as ion conductors for at least one of: the electrolysis of water, electrolysis of carbon dioxide, batteries, electric power generation using fuel cells, water purification, and CO₂ capture systems.

### Specific Example 2

The objective of this example is to show that an anion-conducting membrane comprising a polymer comprising the reaction products of vinylbenzyl-Rₛ, vinylbenzyl-Rₓ and styrene-Rₜ, wherein
(a) Rₛ is a positively charged amine or phosphine group,
(b) Rₓ is independently selected from linear alkyls, branched alkyls, cyclic alkyls, heteroalkyls, aryls, heteroaryls, alkylaryls, and heteroalkylaryls,
(c) Rₜ is independently selected from linear alkyls, branched alkyls, cyclic alkyls, heteroalkyls, aryls, heteroaryls, alkylaryls, and heteroalkylaryls,
(d) Rₓ is a different chemical species than Rₛ,
   also has properties that make the membrane useful for at least one of: the electrolysis of water and carbon dioxide, batteries, electric power generation using fuel cells and water purification.

First a terpolymer comprising the reaction products styrene, vinylbenzyl chloride (VBC) and 4-(3-butenyl)styrene was synthesized.
(a) Reacting VBC with a Grignard reagent 3-Butenylmagnesium bromide (Sigma Aldrich) in tetrahydrofuran (THF) to yield 4-(3-butenyl)styrene
(b) Mixing 10 grams of styrene, 3 grams of 4-(3-butenyl)styrene, 1 gram of VBC and 0.14 g of AIBN in 20 grams of chlorobenzene, and polymerizing as in step 2 of Specific Example 1 above. The resultant polymer was functionalized with Tetramethyl Imidazole (TMIM) as described in steps 3 and 4 of Specific Example 1 above, and a membrane was prepared as described in step 5 of Specific Example 1. This provided a membrane comprising a copolymer comprising the reaction products of vinylbenzyl-Rₛ, vinylbenzyl-Rₓ and styrene-Rₜ where Rₛ=TMIM, Rₓ=a linear alkyl, and Rₜ=H.

Polymers with Rₓ=Branched alkyl, a cyclic alkyl, a heteroalkyl, an aryl, an alkylaryl and a heteroalkylaryls can be synthesized in a similar manner by replacing Grignard reagent in step (a) in the previous paragraph with a Grignard reagent such as Isobutylmagnesium bromide (Sigma Aldrich), Cyclohexylmagnesium chloride (Sigma Aldrich), (1,3-Dioxan-2-ylethyl)magnesium bromide (Sigma Aldrich), 2-Methylbenzylmagnesium chloride (Sigma Aldrich), Benzylmagnesium chloride (Sigma Aldrich), 3-Methoxybenzylmagnesium chloride (Sigma Aldrich). Polymers with heteroaryls can be synthesized using the heteroaryl Grignard reagents disclosed in Barl, et al. (Heterocycles, Vol. 88, No. 2, 2014, pp. 827-844).

In a similar manner, polymers where Rₜ is independently selected from linear alkyls, branched alkyls, cyclic alkyls, heteroalkyls, aryls, heteroaryls, alkylaryls, and heteroalkylaryls, can be manufactured by first creating a styrene-Rₜ by reacting VBC with one of the Grignard reagents discussed in the previous paragraph and then creating a membrane by substituting the styrene-Rₜ for styrene in steps 1 to 5 of Specific Example 1.

The specific area resistance the membrane produced in Specific Example 2 was also measured. The membrane had an area specific resistance below 0.1 ohm-cm² in 1 M KOH so that it may be useful for at least one of: the electrolysis of water and carbon dioxide, batteries, electric power generation using fuel cells and water purification.

### Specific Example 3

The objective of this example is to show that an anion-conducting membrane comprising a polymer comprising the reaction products of vinylbenzyl-Rₛ, vinylbenzyl-Rₓ and styrene-Rₜ wherein
(a) Rₛ is a positively charged amine or phosphine group,
(b) Rₓ is Cl, OH, or a crosslink to other parts of the membrane,
(c) Rₜ is hydrogen,
(d) Rₓ is a different chemical species than Rₛ,
   also has properties that make the membrane useful for at least one of: the electrolysis of water and carbon dioxide, batteries, electric power generation using fuel cells and water purification.

First a PSTMIM membrane was created following the procedure in specific example 1.

Next the membrane was soaked in 1 M KOH for 4 hours at room temperature. NMR as described in U.S. Pat. No. 9,943,841 shows that the resultant polymer contains benzyl-Rₛ groups, and benzyl-Rₓ groups, Rₛ=TMIM and Rₓ=OH. NMR also shows evidence of crosslinks through the benzyl group.

The specific area resistance the membrane produced in Specific Example 3 was also measured. The membrane had an area specific resistance below 0.1 ohm-cm² in 1 M KOH so that it may be useful for at least one of: the electrolysis of water and carbon dioxide, batteries, electric power generation using fuel cells and water purification.

### Specific Example 4

The objective of this example is to provide additional examples of anion-conducting membranes comprising a polymer comprising the reaction products of vinylbenzyl-Rₛ, vinylbenzyl-Rₓ and styrene-Rₜ wherein
(a) Rₛ is a positively charged amine or phosphine group,
(b) Rₓ is an amine
(c) Rₜ is hydrogen.
(d) Rₓ is a different chemical species than Rₛ
   also has properties that make the membrane useful for at least one of: the electrolysis of water and carbon dioxide, batteries, electric power generation using fuel cells and water purification.

In an alternate synthesis the membrane of Specific Example 1 with Rₛ=tetramethylimidazole was soaked overnight in an aqueous solution of one of the following heteroalkyls or heteroalkylaryls. More specifically the membrane was submerged in an aqueous solution with 25 ml of water and 3.1 g of one of the following 1,1,3,3-tetramethylguanidine, N,N,N′-trimethylethylenediamine, ethylenediaminetetraacetic acid, ethanol amine, triethanol amine, hexamethylene tetramine, dimethyl indole and 2,2′-bipyridyl. Only dimethyl indole and 2,2′-bipyridyl failed to completely dissolve in water due to their lower solubility. This gave membranes where Rₓ groups are heteroalkyls and heteroalkylaryls.

The specific area resistance of the each of the membranes produced in Specific Example 4 was also measured. In all cases the resultant membranes had an area specific resistance below 0.1 ohm-cm² in 1 M KOH so that they are useful for at least one of: the electrolysis of water and carbon dioxide, batteries, electric power generation using fuel cells and water purification.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. An anion-conducting membrane comprising a polymer comprising the reaction product of vinylbenzyl-Rₛ, vinylbenzyl-Rₓ and styrene-Rₜ, wherein:
(a) Rₛ is a positively charged amine or phosphine group,
(b) Rₓ is independently selected from OH—, halogens, linear alkyls, branched alkyls, cyclic alkyls, heteroalkyls, aryls, heteroaryls, alkylaryls, and heteroalkylaryls.
(c) Rₜ is independently selected from hydrogen, OH—, halogens, linear alkyls, branched alkyls, cyclic alkyls, heteroalkyls, aryls, heteroaryls, alkylaryls, and heteroalkylaryls,
(d) Rₓ is a different chemical species than Rₛ,
(e) styrene-Rₜ is a different chemical species than vinylbenzyl-Rₛ and vinylbenzyl-Rₓ,
(f) the total weight of the vinylbenzyl-Rₛ is at least 10% of the weight of the polymer,
(g) the total weight of the vinylbenzyl-Rₓ is at least 1% of the weight of the polymer,
(h) the total weight of the styrene-Rₜ is at least 1% of the weight of the polymer.

2. The membrane of claim 1, wherein the total weight of styrene-Rₜ is at least 10% of the weight of the polymer.

3. The membrane of claim 1, wherein the total weight of vinylbenzyl-Rₓ is at least 10% of the weight of the polymer.

4. The membrane of claim 1, wherein the vinylbenzyl-Rₛ comprises the reaction product of benzyl-X, wherein X is a halogen, with at least one of: 1,2,2,6,6-pentamethylpiperidine, 1,2,2,5,5-pentamethylpyrrolidine, tetramethylimidazole, triethylamine, tripropylamine, trimethylamine, N-methylpiperdine, 1-ethylpiperidine, piperidine, 1,4′-bipiperidine, 1-methylpyrrolidine, 2,2,6,6-tetramethylpiperidine, pyrrolidine, 1-pyrrolidine ethanamine, 2,3,5-trimethylpyridine, 2,4,6-trimethylpyridine, 2,6-dimethylpyridine, 2,4-dimethylpyridine, 2,3,5-trimethylpyridine, 4-methyl-2-(1-pyrrolyl)pyridine, 2-methylpyridine, 3-methylpyridine, 4-methylpyridine, pyridine, 4,4′-dipyridyl, 2,2′-bipyridyl, tributylamine, N,N-diisopropylethylamine, triphenylamine, N,N-dimethylcyclohexylamine, N,N-dicyclohexylmethylamine, triphenylphosphine, 1,2-dimethylindole, indole, 1-methylindole, hexamethylenetetramine, 2,3,5,6-tetramethylpyrazine, 2,3,5-trimethylpyrazine, 2,3-dimethylpyrazine, 3-methylpyridazine, 2-methylpyrazine, 2,3-diethylpyrazine, ethylpyrazine, pyrazine, 1-methylimidazole, pyrimidine, 4-methylpyrimidine, pyridazine, triazole, 3,5-dimethyl-1,2,4-triazole, 1,2-dimethylimidazole, 2,4,5-triphenylimidazole, 1-decyl-2-methylimidazole, 1-(2-hydroxyethyl)imidazole, guanidine, tetramethyl guanidine, dipiperidine, dipyridine, ethylenediamine, propylenediamine, N,N,N′-trimethylethylenediamine, ethylenediaminetetraacetic acid, alkyldiamines, other diamines, ethanolamine, triethanolamine, methylethanolamine, dimethylethanolamine, propanolamine, 3-butenylmagnesium, isobutylmagnesium bromide, cyclohexylmagnesium chloride, and amino acid.

5. The membrane of claim 4, wherein vinylbenzyl-Rₓ comprises at least one of:
(i) benzyl-OH,
(ii) benzyl-X, wherein X is a halogen,
(iii) benzyl crosslinked to vinylbenzyl-Rₛ, styrene-Rₜ or a different vinylbenzyl-Rₓ,
(iv) the reaction product of benzyl-X with at least one of: 1,2,2,6,6-pentamethylpiperidine, 1,2,2,5,5-pentamethylpyrrolidine, tetramethylimidazole, triethylamine, tripropylamine, trimethylamine, N-methylpiperdine, 1-ethylpiperidine, piperidine, 1,4′-bipiperidine, 1-methylpyrrolidine, 2,2,6,6-tetramethylpiperidine, pyrrolidine, 1-pyrrolidine ethanamine, 2,3,5-trimethylpyridine, 2,4,6-trimethylpyridine, 2,6-dimethylpyridine, 2,4-dimethylpyridine, 2,3,5-trimethylpyridine, 4-methyl-2-(1-pyrrolyl)pyridine, 2-methylpyridine, 3-methylpyridine, 4-methylpyridine, pyridine, 4,4′-dipyridyl, 2,2′-bipyridyl, tributylamine, N,N-diisopropylethylamine, triphenylamine, N,N-dimethylcyclohexylamine, N,N-dicyclohexylmethylamine, triphenylphosphine, 1,2-dimethylindole, indole, 1-methylindole, hexamethylenetetramine, 2,3,5,6-tetramethylpyrazine, 2,3,5-trimethylpyrazine, 2,3-dimethylpyrazine, 3-methylpyridazine, 2-methylpyrazine, 2,3-diethylpyrazine, ethylpyrazine, pyrazine, 1-methylimidazole, pyrimidine, 4-methylpyrimidine, pyridazine, triazole, 3,5-dimethyl-1,2,4-triazole, 1,2-dimethylimidazole, 2,4,5-triphenylimidazole, 1-decyl-2-methylimidazole, 1-(2-hydroxyethyl)imidazole, guanidine, tetramethyl guanidine, dipiperidine, dipyridine, ethylenediamine, propylenediamine, N,N,N′-trimethylethylenediamine, ethylenediaminetetraacetic acid, alkyldiamines, other diamines, ethanolamine, triethanolamine, methylethanolamine, dimethylethanolamine, propanolamine, 3-butenylmagnesium, isobutylmagnesium bromide, cyclohexylmagnesium chloride, and amino acid.

6. The membrane of claim 5, wherein at least one of Rₛ, and Rₓ are not positively charged cyclic amines, Cl or OH.

7. The membrane of claim 6, wherein both Rₛ, and Rₓ are not positively charged cyclic amines, Cl or OH.

8. The membrane of claim 1, wherein Rₜ is hydrogen or a linear alkyl.

9. The polymer in claim 2, wherein the polymer has a molecular weight between 1000 and 10,000,000 atomic units (A.U.)

10. The membrane of claim 1, wherein the membrane thickness is between 10-300 micrometers.

11. The membrane of claim 1, wherein the membrane has an area specific resistance of 0.1 ohm-cm² or less.

12. A battery, fuel cell, electrolyzer, water purification system or CO₂ capture system comprising the membrane of claim 1.
